(19) United States
(12) Patent Application Publication
(10) Pub. No.: US 2011/0230209 A1
(43) Pub. Date: Sep. 22, 2011

(54) Method and Mobile Device for Automatic Activation of Applications

(75) Inventor: Jochen KILIAN, Rothenburg ob der Tauber (DE)

(73) Assignee: DSP Group Ltd., Herzelia (IL)

(21) Appl. No.: 12/728,298

(22) Filed: Mar. 22, 2010

(51) Int. Cl. H04W 24/00

(52) U.S. Cl. 455/456.3

(57) ABSTRACT

A mobile device and method for automatically activating an application, based on the location of the mobile device.

A user of the mobile device associates a location with an application or a profile to be activated at the particular location. The location can be either absolute, or relative to a second device such as a charger or a docking station. When the mobile device is connected to or in proximity to the absolute location or the second device, the current status or profile of the mobile device is stored, and the indicated application is activated.

When the mobile device leaves the destination location, the application or profile stops, and the mobile device resumes its previous profile, or a default profile.

### TECHNICAL FIELD

The present disclosure relates to mobile devices in general, and to activating an application in accordance with the device location, in particular.

### BACKGROUND

In recent decades, electronic technology and in particular communication-related technology has revolutionized our everyday lives. Electronic devices such as PDA's, cell phones, mobile media players and digital cameras have permeated the lives of almost every person living in the developed world, and quite a number of people living in undeveloped countries. It has become almost impossible for many people to function without access to their electronic devices. In order to handle the proliferation of devices providing functionalities and to avoid the need to carry a multiplicity of devices, the next natural step was the consolidation of multiple applications into a single device.

Thus, a quite standard device today serves for multiple purposes. For example, a mobile phone may also be used as a clock, an alarm clock, and as an audio and video player; a cordless phone may also be used as a clock, a remote control, or a news feed reader; an infotainment center may also be used as a web browsing device, a remote control, a recipe book, a calendar or the like.

However, with this tremendous proliferation in the number of applications, a tradeoff has developed between enhanced productivity and simplicity or convenience. A person may need to navigate through multiple menus and select from a multiplicity of options in each stage, in order to activate the option he needs at the moment, and set the required configuration.

In some devices, profiles are used for switching between operation modes. However, the user still has to navigate and choose or create the right profile, and later switch back to the default profile or to another one.

There is thus a need in the art for a method and mobile device that will automatically select the application required for a user, or will automatically set the correct profile or configuration.

### SUMMARY

A method and mobile device for automatically activating location-dependent applications or profiles.

A first aspect of the disclosure relates to a mobile device, comprising: an input component for receiving from a user an indication to an application of the mobile device, the application to be activated in association with a destination location; a location-application association component for associating the application with the location; a location identification component for identifying when the mobile device is located at a current location complying with the destination location; and an application activation and deactivation component for activating the application when the current location of the device complies with the destination location, and for deactivating the application when the current location of the device is not in compliance with the destination location. Within the mobile device, the location identification component optionally uses technology selected from the group consisting of: radio frequency; identifying an identifier of a second device connected to the mobile device; identifying a power or charger characteristic of a second device connected to the mobile device; and Global Positioning System. Within the mobile device, the destination location is optionally an absolute location, and the current location complies with the destination location if the current location is at most a predetermined distance away from the destination location. Within the mobile device, the destination location is optionally a location of a second device, and wherein the current location complies with the destination location if the mobile device is plugged into the second device. Within the mobile device, the second device is optionally a charger or a docking station. Within the mobile device, the destination location is optionally a location of a second device, and the current location optionally complies with the destination location if the mobile device is at most a predetermined distance away from the destination location. Within the mobile device, the second device is optionally a charger or a docking station. Within the mobile device, the application is optionally a profile of the mobile device.

Another aspect of the disclosure relates to a method for activating a mobile device in accordance with a location, comprising: receiving an indication to a destination location and to an application of the mobile device, the application to be activated in association with a destination location; identifying that the mobile device is at a current location complying with the destination location; activating the application; identifying that the mobile device is at a new location not complying with the destination location; and deactivating the application. Within the method, identifying that the current location complies with the destination location optionally uses technology selected from the group consisting of: radio frequency; identifying an identifier of a second device connected to the mobile device; identifying a power or charger characteristic of a second device connected to the mobile device; and Global Positioning System. Within the method, the destination location is optionally an absolute location, and the current location optionally complies with the destination location, if the current location is at most a predetermined distance away from the destination location. Within the method, the destination location is optionally a location of a second device, and the current location optionally complies with the destination location if the mobile device is plugged into the second device. Within the method, the second device is optionally a charger or a docking station. Within the method, the destination location is optionally a location of a second device, and the current location optionally complies with the destination location if the mobile device is at most a predetermined distance away from the destination location. Within the method, the second device is optionally a charger or a docking station. Within the method, the application is optionally a profile of the mobile device. The method can further comprise activating a previously active application of the mobile device or a default application.

### DESCRIPTION OF THE DRAWINGS

The present disclosure will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a schematic illustration of a mobile device in multiple location-dependent modes, in accordance with the disclosure;

FIG. 2 is a flowchart of the main steps in a method for operating a mobile device in accordance with the location of the mobile device, in accordance with the disclosure; and

FIG. 3 is a schematic illustration of a mobile device with location identification and utilizing capabilities, in accordance with the disclosure.

### DETAILED DESCRIPTION

Many applications provided by mobile devices are used only, or mainly, at specific locations. Therefore, there is thus provided a method and multifunctional mobile device for switching the operation mode of the device or activating an application in accordance with the device location.

The location can be either absolute, as determined for example by a global positioning system, or relative to a device such as a docking station or a charger.

In the description below, the terms application and profile are used interchangeably, and refer to a certain mode the device is in, or to a certain activity or application to be executed by the device.

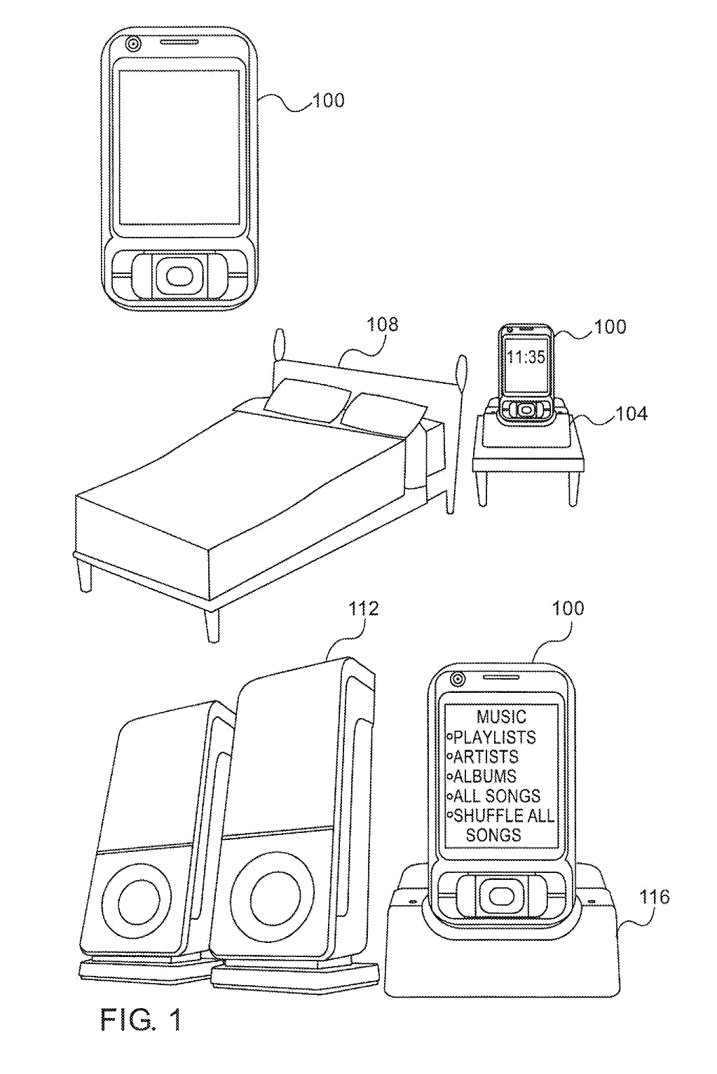

Referring now to FIG. 1, showing some exemplary situations in which the operation mode or application is changed in accordance with the location of the device.

Mobile device 100 can be used, for example, as a mobile phone, an alarm clock or as an audio source. Suppose the owner of the device has one docking station for the mobile device at his bedside, and another docking station close to his stereo.

In default situations, when the device is not plugged into any of the docking stations, mobile device 100 operates in the normal mode according to the selected settings, which is usually a phone, which can ring or vibrate, and enables the receiving or initiating of vocal communications or text messages.

When the user plugs mobile device 100 into bedside docking station 104 which is placed near the user's bed 108, the device can automatically switch to a predefined bed-side profile which includes activating the alarm clock application, activating the ringer to ensure that mobile device 100 rings at the required time, setting the display to show the time in a clear manner as shown in FIG. 1, and setting the device into flight mode in order to ensure that the user is not disturbed during the night. Alternatively, in some embodiments, the device can be set to normal mode but to automatically activate the answering machine or service for all incoming calls, or otherwise cause the device not to ring. In yet another alternative, calls from one of a predetermined number list can override the setting and activate the ringer even during the night.

When the user wakes up and unplugs mobile device 100 from docking station 104, the device switches automatically back to the setting in which it was before it was plugged into the docking station 104, or into a default mode.

In another usage, the user may want to listen to some audio content stored on mobile device 100 via his stereo equipment 112. The user then plugs the mobile device 100 into stereo docking station 116, mobile device 100 recognizes docking station 116, and switches to a predefined profile intended for music playing, including for example opening the audio player application as shown, setting the volume setting to a predetermined level and playing the last active song which was active before.

When the user unplugs mobile device 100 from docking station 116, mobile device 100 assumes its previous or default setting.

In another example, a mobile infotainment device can be used in multiple scenarios. For example, when the device is plugged into a docking station in the kitchen, the device automatically displays a stop watch, the weather forecast and a recipe of the day downloaded from the web. When the device is plugged into or placed near the TV docking station, the device becomes a remote control, and its display becomes a second screen, showing the same content as the TV. When the device is at neither docking station, it activates and displays the web browser.

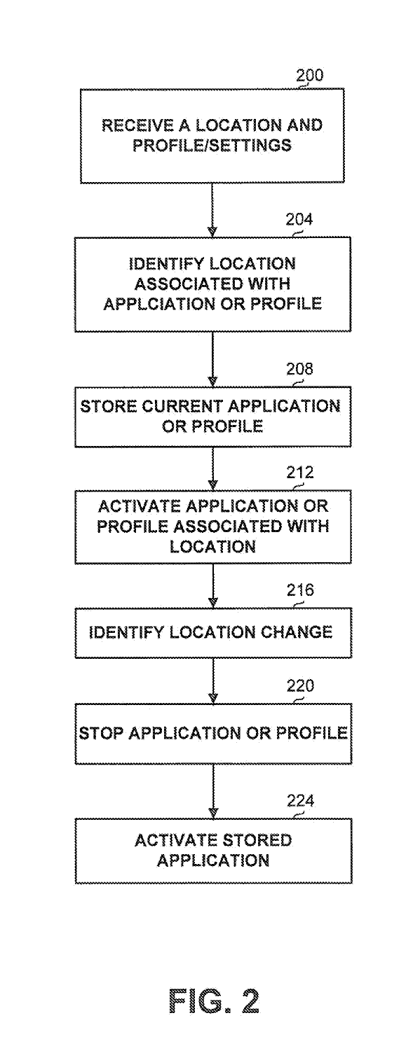

Referring now to FIG. 2, showing a flowchart of the main steps in a method for operating a mobile device in accordance with the location of the mobile device.

On step 200, a pair consisting of a destination location and a profile, setting or application is received from a user, optionally through a setup application having a dedicated user interface. In order to create the pair, the user places the mobile device at the destination location at which the profile or application is to be activated.

The location can be absolute, and be determined for example through a Global Positioning System (GPS). Alternatively, the location can be relative to a second device, such as a docking station or a charger.

If the mobile device is pluggable into the second device, identification such as USB identification can be used. In cordless phones, RF characteristic of the DECT base can be identified on plug-in or from close proximity. An identifier such as a serial number, power or charger characteristics of the charger, cradle or docking station, such as voltage, current, or ripple can be identified by the mobile device and used for determining the relative location at which the profile or application is to be activated.

If the mobile device is not plugged into the second device but is rather in proximity therewith, the location can be identified through any wireless technology, such as radio frequency identification (RF-ID) mechanism, Wi-Fi, or the like. For non-plugged devices, such as RF-ID devices, the location includes identification of the second device, and maximal distance between the mobile device and the second device for starting the application or profile. In some embodiments the association can be made to all devices of the same type, for example all docking stations of the particular type, and not only to the particular device introduced.

Relative location is particularly useful when the user moves the second device, for example takes the charger at his bed-side with him when traveling.

The application or profile to be activated at the location can be set in a multiplicity of ways. In one embodiment, the application can be set using a dedicated interface, a macro, or a recording mode, in which the user's actions are recorded and stored. In another embodiment, certain modes of the mobile device can be pre-stored and named, and then selected. In yet another embodiment, export and import of modes can be used, including importing from a file edited externally to the device, such as a text or an XML file.

It will be appreciated that step 200 is performed at least once for each location in which a specific application or profile is to be activated. The one or more location—application associations can be stored within the device in any required format.

On step 204 the mobile device identifies its location and discovers whether its current location complies with the destination location associated with a predetermined profile or application. The discovery can be activated when the device is plugged into a docking station or a charger. In addition, and if there is one or more applications or profiles associated with an absolute location, the device can predetermine its location at predetermined time intervals and see if the location complies with one of the locations associated with an application or profile. The device can also, at predetermined time intervals, determine whether it is within the required proximity from a particular device associated with an application or profile. The discovery can be eliminated if the mobile device is executing another application, such as when a call is in progress or the device is playing audio. Alternatively, location discovery can take place, but the actual activation of the profile or application will only take place when the other activity is terminated, for example the call is hung up.

If the destination location is an absolute location, then the current location complies with the destination location if the current location is at most at a predetermined distance from the destination location.

If the destination location is a location of a second device such as a docking station or charger, the current location complies with the destination location if the mobile device is plugged into the second device, or if the mobile device is at most at a predetermined distance away from the second device.

On step 208, subject to the discovery of a location associated with an application or profile, the current status or activity of the device may be stored.

On step 212, the application or profile associated with the location is activated.

On step 216, the mobile device discovers that its location has changed. The location change can be determined when the device is unplugged from a docking station or charger, or as detailed in association with step 204 above, in accordance with an absolute location or a location relative to another device.

On step 220 the location-dependent application or profile as activated on step 212 is stopped.

On step 224, the stored application or profile are resumed. Alternatively and according to the user's choice, a default mode of the mobile device can be assumed.

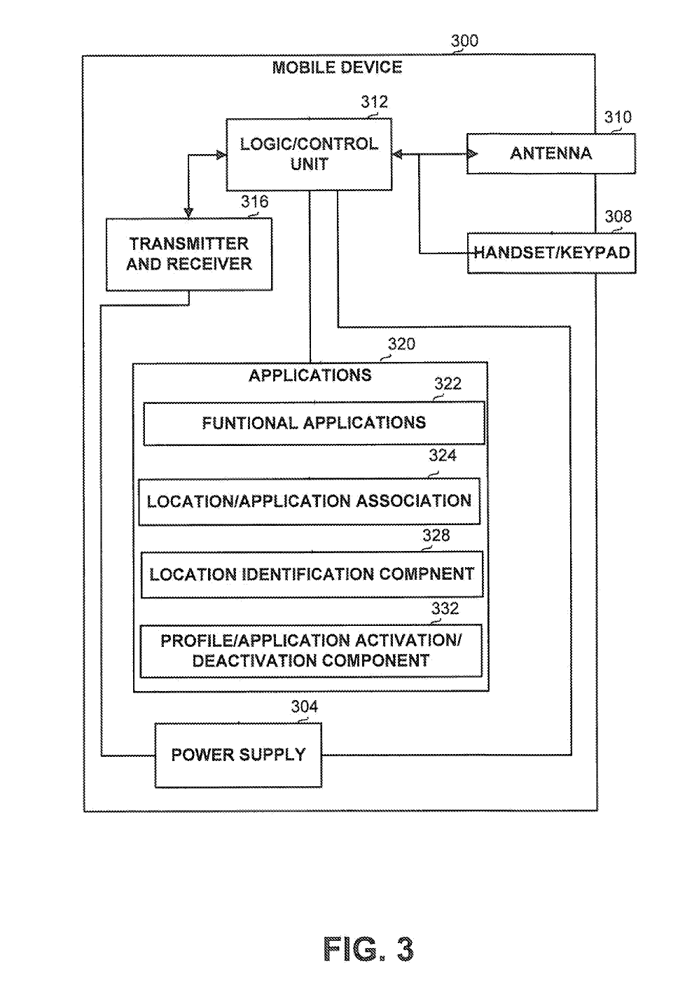

Referring now to FIG. 3, showing a schematic block diagram of a mobile device in which applications or profiles are activated according to a location.

The mobile device, generally referenced 300 comprises power supply 304, usually one or more rechargeable batteries. In some embodiments the batteries can be Nickel-cadmium (NiCd) batteries, or newer nickel-metal hydride (NiMH) batteries, which provide for longer talk periods as compared to lower-cost conventional NiCd batteries. However, any other battery type can be used.

In some embodiments mobile device 300 is a mobile phone. Some of the components detailed below indeed relate to a mobile phone, but may be unnecessary if other devices are used.

Mobile device 300 comprises handset and keypad components 308 and antenna 310. Handset and keypad 308 provide the interface between the user and the device. The keypad, which can be replaced by another input device such as a touch screen, a voice recognition unit, or the like, provides the user access to the features of the device, including receiving and initiating calls, text messages, web surfing and various other applications. The input device is adapted to receive from a user an indication to an application or profile of the mobile device, the application to be associated with a location.

Antenna 310 of mobile device 300 can consist of a flexible or extendible unit mounted. Antenna 310 and the cables connecting it to the transmitters must have electrical performance characteristics that match the transmitting circuitry, frequency, and power levels.

Device 300 comprises transmitter and receiver components 316 which may be controlled by logic/control unit 312. Transmitter and receiver components 316 perform the actual communication between the mobile phone and external entities in accordance with the used communication protocols.

Mobile device 300 comprises logic/control unit 312 responsible for controlling and activating the various components of mobile device 300. Logic/control unit 312 is responsible for assigning and authenticating the device's telephone number with the service provider, and for interacting with the cellular network protocols. Logic/control unit 312 is also responsible for executing any one or more of applications 320. Logic/control unit 312 can be implemented as software comprising one or more sets of interrelated computer instructions, as hardware, or as configurable hardware such as field programmable gate array (FPGA) or application specific integrated circuit (ASIC).

Applications 320 may include all functional applications 322 of a mobile phone, such as but not limited to editing messages, taking pictures, playing audio, games, or others. In addition, in order to enable automatic activation of profiles and applications, applications 320 comprise location/application association component 324 which provides a user with a user interface for identifying a location and associating an application or a profile with the location, and storing the association.

Applications 320 further comprise location identification component 328 for identifying whether the device is at a location associated with a profile or application, and profile/application activation and deactivation component 332 for storing the profile in effect and activating the application or profile indicated for the particular location. Component 332 is also responsible for deactivating the profile or application when the location of the mobile device does not match the required location any more, and for assuming the previous profile or application, or a default one.

Any of applications 320 can be implemented as software comprising one or more sets of interrelated computer instructions, as hardware, or as configurable hardware such as field programmable gate array (FPGA) or application specific integrated circuit (ASIC).

It will be appreciated that the disclosed method and mobile device are exemplary only, and that other implementations can be designed along the same guidelines. In particular, fewer, additional, or different steps or components or connections therebetween can be used. It will also be appreciated that the method can be applied for any mobile device, and is not limited to a phone or to any other device.

It will be appreciated that each docking station or location can be identified by multiple mobile devices, wherein each mobile device can associate the location with another profile or application to be activated. It will also be appreciated that additional parameters can be conditioned on for activating a profile or application, such as time or daylight.

It will also be appreciated that the automatic activation mechanism can be switched on and off in accordance with the user's preferences. When switched off, the mobile device will not automatically start a location-based application. The disclosed method and mobile device provide automatic location-based activation and deactivation of profiles and applications. Once the device is placed at the designated location, which can relate to absolute coordinates, physical connection to a device, or predetermined proximity to another device, the profile or application start without requiring the user to take any action.

It will be appreciated by persons skilled in the art that the present disclosure is not limited to what has been particularly shown and described hereinabove. Rather the scope of the present disclosure is defined only by the claims which follow.

1. A mobile device, comprising:
an input component for receiving from a user an indication to an application of the mobile device, the application to be activated in association with a destination location;
a location-application association component for associating the application with the location;
a location identification component for identifying when the mobile device is located at a current location complying with the destination location; and
an application activation and deactivation component for activating the application when the current location of the device complies with the destination location, and for deactivating the application when the current location of the device is not in compliance with the destination location.

2. The mobile device of claim 1 wherein the location identification component uses technology selected from the group consisting of: radio frequency; identifying an identifier of a second device connected to the mobile device; identifying a power or charger characteristic of a second device connected to the mobile device; and Global Positioning System.

3. The mobile device of claim 1 wherein the destination location is an absolute location, and the current location complies with the destination location if the current location is at most a predetermined distance away from the destination location.

4. The mobile device of claim 1 wherein the destination location is a location of a second device, and wherein the current location complies with the destination location if the mobile device is plugged into the second device.

5. The mobile device of claim 4 wherein the second device is a charger or a docking station.

6. The mobile device of claim 1 wherein the destination location is a location of a second device, and wherein the current location complies with the destination location if the mobile device is at most a predetermined distance away from the destination location.

7. The mobile device of claim 6 wherein the second device is a charger or a docking station.

8. The mobile device of claim 1 wherein the application is a profile of the mobile device.

9. A method for activating a mobile device in accordance with a location, comprising:
receiving an indication to a destination location and to an application of the mobile device, the application to be activated in association with a destination location;
identifying that the mobile device is at a current location complying with the destination location;
activating the application;
identifying that the mobile device is at a new location not complying with the destination location; and
deactivating the application.

10. The method of claim 9 wherein identifying that the current location complies with the destination location uses technology selected from the group consisting of: radio frequency; identifying an identifier of a second device connected to the mobile device; identifying a power or charger characteristic of a second device connected to the mobile device; and Global Positioning System.

11. The method of claim 9 wherein the destination location is an absolute location, and the current location complies with the destination location, if the current location is at most a predetermined distance away from the destination location.

12. The method of claim 9 wherein the destination location is a location of a second device, and wherein the current location complies with the destination location if the mobile device is plugged into the second device.

13. The method of claim 12 wherein the second device is a charger or a docking station.

14. The method of claim 9 wherein the destination location is a location of a second device, and wherein the current location complies with the destination location if the mobile device is at most a predetermined distance away from the destination location.

15. The method of claim 14 wherein the second device is a charger or a docking station.

16. The method of claim 9 wherein the application is a profile of the mobile device.

17. The method of claim 9 further comprising activating a previously active application of the mobile device or a default application.
